(19) United States
(12) Patent Application Publication
(10) Pub. No.: US 2023/0035548 A1
(43) Pub. Date: Feb. 2, 2023

(54) DEVICE FOR BENDING AT LEAST ONE CONDUCTOR ELEMENT WHICH IS U-SHAPED IN AN INITIAL STATE, AND A CORRESPONDING METHOD

(71) Applicant: Gehring Technologies GmbH + Co. KG, Ostfildern (DE)

(72) Inventors: Thomas Mergler, BEDIZZOLE (IT); Pier Vai, POMPIANO (IT)

(73) Assignee: Gehring Technologies GmbH + Co. KG, Ostfildern (DE)

(21) Appl. No.: 17/911,960

(22) PCT Filed: Mar. 11, 2021
(86) PCT No.: PCT/EP2021/056224

§ 371 Date: Sep. 15, 2022

(30) Foreign Application Priority Data
Mar. 16, 2020 (DE) 10 2020 107 192.2

(51) Int. Cl. H02K 15/04

(52) U.S. Cl. CPC H02K 15/0421

(57) ABSTRACT

The invention relates to a device for bending at least one conductor element which is U-shaped in an initial state, wherein the device includes a first pivot unit having a first limb-receiving means, a second pivot unit having a second limb-receiving means and a guide assembly comprising a first guide element having a first shaping surface and a second guide element having a second shaping surface, and a corresponding method for bending at least one conductor element which is U-shaped in an initial state.

### BACKGROUND

The invention relates to a device for bending at least one conductor element which is U-shaped in an initial state, and to a corresponding method.

In what is known as hairpin technology, hairpin-shaped conductor elements (hairpins) in the broadest sense are used together with individual special pins of different types in a stator core. Hairpins are thus conductor elements having substantially two elongate limbs and a connecting portion connecting these two limbs. The plurality of conductor elements is usually arranged in such a way that the conductor elements are arranged in rows, each of which extends in a radial direction, on a plurality of circular paths extending in a circumferential direction. The free ends of the limbs protrude from the stator core on one side thereof, and the connecting portions are arranged on the other side of the stator core.

A design that is as efficient and compact as possible is achieved by different geometries, in particular of the connecting portion of the individual conductor elements. In this case, the desired geometries are produced by bending the conductor elements and in particular the connecting portion.

### SUMMARY OF THE INVENTION

The object of the present invention is to provide a device and a method with which bending can be carried out as efficiently and precisely as possible, a hairpin being produced which allows the highest possible arrangement density when inserted into the stator core.

The object is achieved by a device according to claim 1 for bending at least one conductor element which is U-shaped in an initial state and which consists of a first straight limb, a second straight limb and an arcuate connecting portion which connects the two limbs.

The device comprises:

A first pivot unit having a first limb-receiving means. The first limb-receiving means is designed to be pivotable about a first pivot axis on a first circular path. The first limb-receiving means is designed to clampingly receive the first limb of the conductor element.

A second pivot unit having a second limb-receiving means. The second limb-receiving means is designed to be pivotable about a second pivot axis on a second circular path. The second limb-receiving means is designed to clampingly receive the second limb of the conductor element.

The first and the second limb-receiving means can be pivoted away from one another in the same pivoting direction on the respective circular paths.

The device further comprises a guide assembly. The guide assembly comprises a first guide element and a second guide element. The first guide element has a first shaping surface and the second guide element has a second shaping surface.

The two guide elements are arranged or can be arranged in such a way that the arcuate connecting portion of a conductor element to be deformed or a plurality of conductor elements to be deformed, in the initial state thereof, can be arranged between the two guide elements in such a way that said conductor elements are guided between the shaping surfaces or can be moved therewith, in particular in the vertical direction.

If a plurality of conductor elements are to be bent or deformed, they are arranged one next to the other between the two guide elements or between the two shaping surfaces. The shaping surfaces can be designed as flat surfaces.

The first guide element and the second guide element can preferably be moved toward and away from one another relative to one another. The distance between the two guide elements and thus between the two shaping surfaces can therefore be varied. Depending on the thickness of a conductor element and/or the number of a plurality of conductor elements arranged one next to the other, the distance in particular between the two specified surfaces can be adjusted accordingly. For this purpose, the two guide elements can be movable or displaceable within the same plane, in particular the horizontal plane.

Preferably, the device can comprise a first guide surface. The first guide surface can in particular be curved and preferably arranged on the first guide element. The first guide surface can be arranged and designed in such a way that when the first pivot unit is pivoted, a deformed portion of the first limb is bent against the first guide surface, so that a contour of the first guide surface is at least partially impressed on the deformed portion of the first limb.

The deformed portion of the first limb extends from the part of the first limb received in the first limb-receiving means in the direction of the connecting portion.

Preferably, the device can comprise a second guide surface. The second guide surface can in particular be curved and preferably arranged on the second guide element. The second guide surface can be arranged and designed in such a way that when the second pivot unit is pivoted, a deformed portion of the second limb is bent against the second guide surface, so that a contour of the second guide surface is at least partially impressed on the deformed portion of the second limb.

The deformed portion of the second limb extends from the part of the second limb received in the second limb-receiving means in the direction of the connecting portion.

The two guide surfaces can have different geometries. For example, a contour of the first and/or the second guide surface that has an edge is conceivable. In this way, for example, a kink could be impressed on the deformed portion of the first or second limb of the conductor element.

The device can preferably comprise at least one shaping element. The shaping element can have a contact surface. The shaping element can be arranged and designed in such a way that the contact surface thereof can be pressed against the deformed portion of the first limb or against the deformed portion of the second limb, so that a contour of the contact surface is at least partially impressed on the deformed portion of the first limb or the deformed portion of the second limb (16). The geometry of the contact surface can be curved and/or have corners and/or edges, for example.

The shaping element can preferably be arranged and designed in such a way that the contact surface of the shaping element and the first guide surface or the contact surface of the shaping element and the second guide surface can be moved toward and away from one another relative to one another. The working surface can thus be adapted to a portion of the first or second limb that has already been bent on the first or second guide surface. For this purpose, the contact surface, the first guide surface and/or the second guide surface can be arranged to be movable or displaceable within parallel planes, in particular within the same plane. These can be horizontal planes, for example, and in particular the same horizontal plane.

The first pivot unit can preferably be arranged and designed in such a way that the first pivot unit is designed to be movable in a direction parallel to the first pivot axis.

The second pivot unit can also be arranged and designed in such a way that the second pivot unit is designed to be movable in a direction parallel to the second pivot axis.

A movement of the first and/or the second pivot unit directed parallel to the relevant pivot axis can be implemented, for example, by means of a helical ramp and a roller rolling thereon and arranged on the first and/or the second pivot unit or a wheel element arranged thereon. However, a slotted guide track extending in a direction parallel to the relevant pivot axis for guiding the first and/or the second pivot unit is also conceivable.

The above object is also achieved by a method according to the independent claim for bending at least one conductor element which is U-shaped in an initial state and which consists of a first straight limb, a second straight limb and an arcuate connecting portion which connects the two limbs, the method comprising the following steps:

Arranging the arcuate connecting portion within a guide assembly. If there are a plurality of conductor elements, these are arranged one next to the other, so that the connecting portions are also arranged correspondingly one next to the other.

Receiving the first limb in a first limb-receiving means in a clampingly fixed manner.

Receiving the second limb in a second limb-receiving means in a clampingly fixed manner.

Pivoting the part of the first limb received in the first limb-receiving means on a first circular path about a first pivot axis in a pivoting direction.

Pivoting the part of the second limb received in the second limb-receiving means on a second circular path about a second pivot axis in the pivoting direction, the arcuate connecting portion of the conductor element being deformed and, in particular in a vertical direction, displaced parallel to the pivot axes, part of the connecting portion being held in its orientation by the guide assembly.

In particular, a plurality of conductor elements are deformed in one procedure. The conductor elements are arranged one next to the other in the initial state. The connecting portions are therefore arranged one next to the other in the horizontal plane, for example. In the initial state, the plurality of conductor elements are of the same design in relation to the geometry of the connecting portion. During deformation, the plurality of conductor elements form a conductor element assembly, which is deformed virtually in the manner of a single conductor element; the conductor elements of the conductor element assembly move relative to one another. Therefore, when reference is made below to the deformation of a conductor element, this also means the deformation of a conductor element assembly. The corresponding statements on the embodiments of the method therefore also apply to the deformation of a conductor element assembly.

Part of the invention is therefore in particular a method for the simultaneous bending of a plurality of conductor elements which form a conductor element assembly, the individual conductor elements and the conductor element assembly being U-shaped in an initial state. The conductor elements and the conductor element assembly further consisting of a first straight limb, a second straight limb and an arcuate connecting portion connecting the two limbs. The method comprises the following steps:

Arranging the arcuate connecting portion of the conductor element assembly within a guide assembly. The plurality of conductor elements are arranged one next to the other, so that the connecting portions are also arranged correspondingly one next to the other.

Receiving the first limb of the conductor element assembly in a first limb-receiving means in a clampingly fixed manner.

Receiving the second limb of the conductor element assembly in a second limb-receiving means in a clampingly fixed manner.

Pivoting the part of the first limb received in the first limb-receiving means on a first circular path about a first pivot axis in a pivoting direction.

Pivoting the part of the second limb received in the second limb-receiving means on a second circular path about a second pivot axis in the pivoting direction, the arcuate connecting portion of the conductor element being deformed and, in particular in a vertical direction, displaced parallel to the pivot axes, part of the connecting portion being held in its orientation by the guide assembly. The orientation of the held portion is therefore not changed; however, it does not have to be clampingly fixed for this purpose, but rather only guided so that its orientation remains unchanged.

If there are a plurality of conductor elements, the connecting portions can all be moved or displaced together in one direction, e.g. the vertical direction. They can also be moved or displaced in a direction which is orthogonal to this direction, e.g. the horizontal direction. In this case, the connecting portions are moved or displaced to different extents in the horizontal direction.

In the present case, clampingly fixed means that the part of the limbs received in the relevant limb-receiving means is fixed or held in its shape and orientation, in particular during bending, and is not bent or deformed. No relative movement is possible between the clampingly fixed part of the limb and the limb-receiving means. This can be implemented by means of clamping elements or clamping jaws.

Pivoting on a path other than a circular path, for example an elliptical path, is also conceivable.

Preferably, when the part of the first limb received in the first limb-receiving means is pivoted, a deformed portion of the first limb is bent against a first guide surface, so that a contour of the first guide surface is at least partially impressed on the deformed portion of the first limb.

The deformed portion of the first limb extends from the part of the first limb received in the first limb-receiving means in the direction of the connecting portion.

Preferably, when the part of the second limb received in the second limb-receiving means is pivoted, a deformed portion of the second limb is bent against a second guide surface, so that a contour of the second guide surface is at least partially impressed on the deformed portion of the second limb.

The deformed portion of the second limb extends from the part of the second limb received in the second limb-receiving means in the direction of the connecting portion.

During pivoting, the connecting portion can preferably be moved in the direction of the part of the first limb received in the first limb-receiving means or in the direction of the part of the second limb received in the second limb-receiving means. At least part of the connecting portion can be held in its orientation by the guide assembly. In other words, this part is not pivoted.

Preferably, when the part of the first limb received in the first limb-receiving means is pivoted, the first limb-receiving means is moved in a direction parallel to the first pivot axis, in particular a vertical direction.

Likewise, when the part of the second limb received in the second limb-receiving means is pivoted, the second limb-receiving means is moved in a direction parallel to the second pivot axis, in particular a vertical direction.

Preferably, the method can further comprise the step of:

Pressing a contact surface against the deformed portion of the first limb and/or against the deformed portion of the second limb, so that a contour of the contact surface is at least partially impressed on the deformed portion of the first limb and/or the deformed portion of the second limb.

A device according to any of claims 1 to 7 can preferably be used when carrying out the method.

### BRIEF DESCRIPTION OF THE DRAWINGS

Further features, details and advantages of the invention can be found in the wording of the claims and in the following description of the embodiment with reference to the drawings, in which:

FIG. 1 is a side view of a conductor element in an initial state;

FIG. 2 is a plan view of a device according to the invention in an initial state;

FIG. 3 is a perspective view of a device according to FIG. 2;

FIG. 4 is a plan view of a device according to FIG. 2 in a pivoted state and

FIG. 5 is a plan view of three conductor elements bent by means of the device.

### DETAILED DESCRIPTION

In the following description and in the figures, corresponding components and elements have the same reference signs. For the sake of clarity, not all of the reference signs are shown in all of the figures.

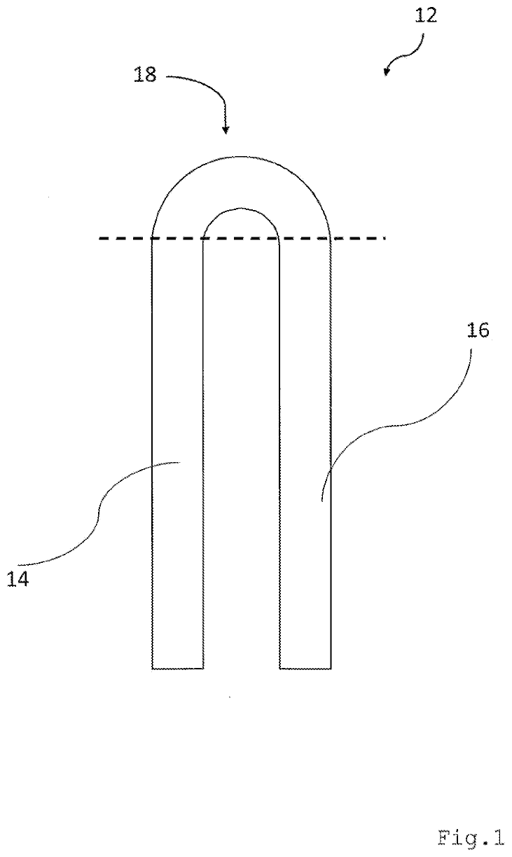

FIG. 1 is a side view of a conductor element 12 in an initial state. The conductor element is U-shaped in the initial state. It has a first limb 14 and a second limb 16. These are connected to one another via an arcuate connecting portion 18. The connecting portion 18 lies above the boundary to the limbs 14 and 16, which is shown by a broken line in FIG. 1.

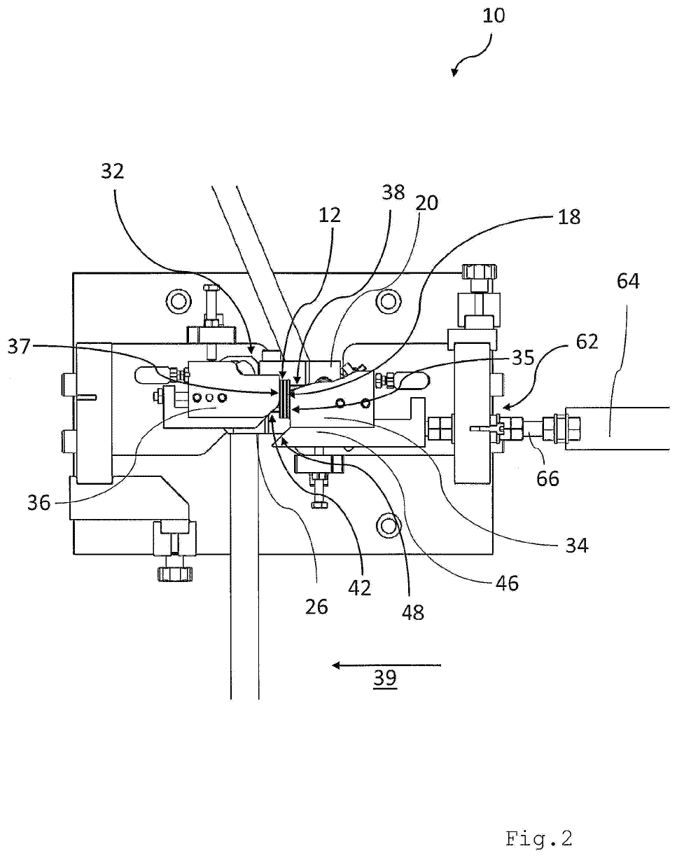

FIG. 2 is a plan view of a device 10 according to the invention in an initial state. In the present case, three conductor elements 12 are shown received in the device 10 in the U-shaped initial state.

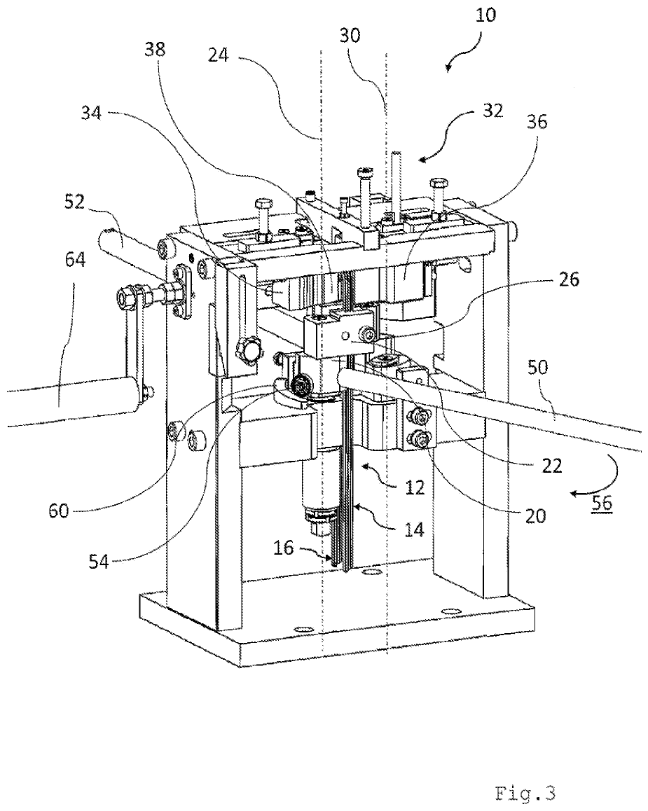

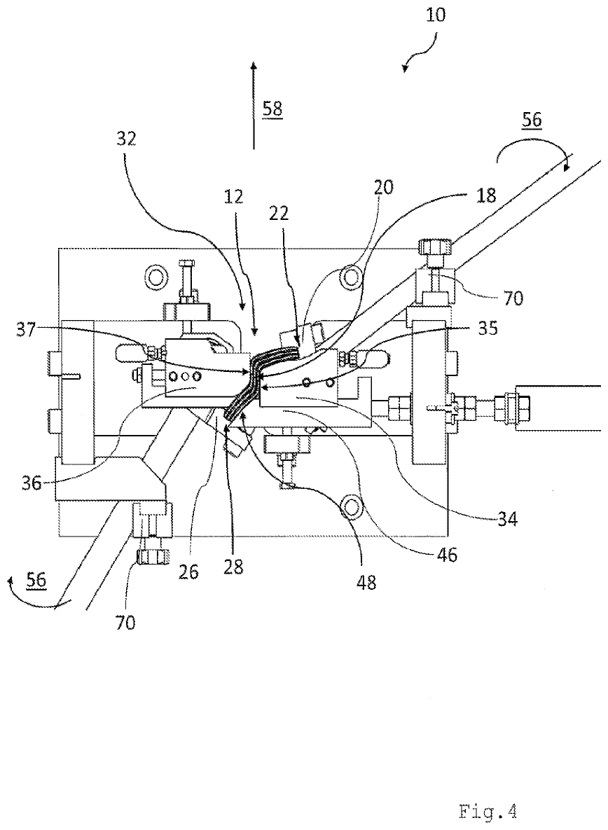

The device 10 comprises a first pivot unit 20 and a second pivot unit 26. The first pivot unit 20 has a first limb-receiving means 22 and the second pivot unit 26 has a second limb-receiving means 28 (see FIGS. 3 and 4).

The first limbs 14 of the three conductor elements 12 are received in the first limb-receiving means 22 in a clampingly fixed manner and the second limbs 16 thereof are received in the second limb-receiving means 28 in a clampingly fixed manner.

The device 10 comprises a guide assembly 32. This consists of two guide elements in the present case: a first guide element 34 and a second guide element 36.

The device 10 further comprises a first shaping surface 35 and a first guide surface 38, the first shaping surface 35 and the first guide surface 38 both being arranged on the first guide element 34.

The device 10 further comprises a second shaping surface 37 and a second guide surface 42, the second shaping surface 37 and the second guide surface 42 both being arranged on the second guide element 34.

In the present case, the shaping surfaces 35, 37 are designed as flat surfaces and the guide surfaces 38, 42 are curved.

Before the conductor elements 12 are bent, they or the guide elements 34, 36 are arranged and aligned relative to one another in such a way that the shaping surfaces 35, 37 are at least partially flush with the sides of the two lateral conductor elements 12. In the present case, the two guide elements 34, 36 are arranged in such a way that the two shaping guide surfaces 35, 37 are aligned parallel to one another.

For this purpose, the two guide elements 34, 36 are arranged such that they can move in the guide direction 39. They can be moved toward and away from one another in the guide direction 39. This means the relative movement of both guide elements 34, 36, so that, for example, the first guide element 34 can be held while the second guide element 36 is moved, or vice versa, or both guide elements 34, 36 are moved simultaneously.

In addition, the device 10 has a shaping element 46 having a contact surface 48. The shaping element 46 is also arranged such that it can be moved in the guide direction 39. In the present case, this is by means of a screw thread 62 into and out of which a threaded rod 66, on which the shaping element 46 is arranged, is screwed in or out by means of a crank 64.

FIG. 3 is a perspective view of a device 10 according to FIG. 2. Here, too, the device 10 is in the initial state, i.e. before bending of the conductor elements 12 and before pivoting of the two pivot units 20 and 26.

The first pivot unit 20 is arranged so as to be pivotable about a first pivot axis 24 on a circular path. The second pivot unit 26 is arranged so as to be pivotable about a second pivot axis 30 on a circular path. The two pivot axes 24 and 30 are indicated by two dashed lines.

The two pivot units 20, 26 can, for example, be pivoted manually by an operator using a first lever 50 and a second lever 52.

In the present case, the first pivot unit 20 is arranged so as to be movable along the first pivot axis 24. For this purpose, the first pivot unit 20 has a roller 54. During the pivoting of the first pivot unit 20 in the pivoting direction 56, the roller 54 runs on a spirally rising ramp 60. The roller 54 therefore rolls up the ramp 60 and moves the first pivot unit 20 in the vertical direction.

In the present case, the second pivot unit 26 is designed to be immovable in the vertical direction, i.e. parallel to the second pivot axis 30. However, it is conceivable that the second pivot unit 26 is also designed to be movable in the vertical direction, analogously to the first pivot unit 20.

In the present case, the two pivot axes 24, 30 are arranged in parallel and spaced apart from one another.

In order to bend the conductor elements 12, the two pivot units 20, 26 are pivoted in the pivoting direction 56 by means of the levers 50, 52. As a result, the limbs 14 and 16 which are received in the two limb-receiving means 22, 28 in a clampingly fixed manner are moved on the respective circular paths about the pivot axes 24, 30.

Since the first pivoting device 20 performs an upward movement along the first pivot axis 24 by means of the roller 54 and the ramp 60 during pivoting, this upward movement is also transmitted to the first limb-receiving means 22 and the first limbs 14 of the conductor elements 12 received therein in a clampingly fixed manner.

FIG. 4 is a plan view of a device 10 according to FIG. 2 in a pivoted state. The pivot units 20, 26 have each been pivoted in the pivoting direction 56 from the initial state shown in FIG. 2. As can be seen from this, the limbs 14 and 16 have been pivoted with the pivot units 20, 26 and their limb-receiving means 22, 28. The conductor elements 12 and in particular their limbs 14, 16 were bent on the two guide surfaces 38, 42 in the process.

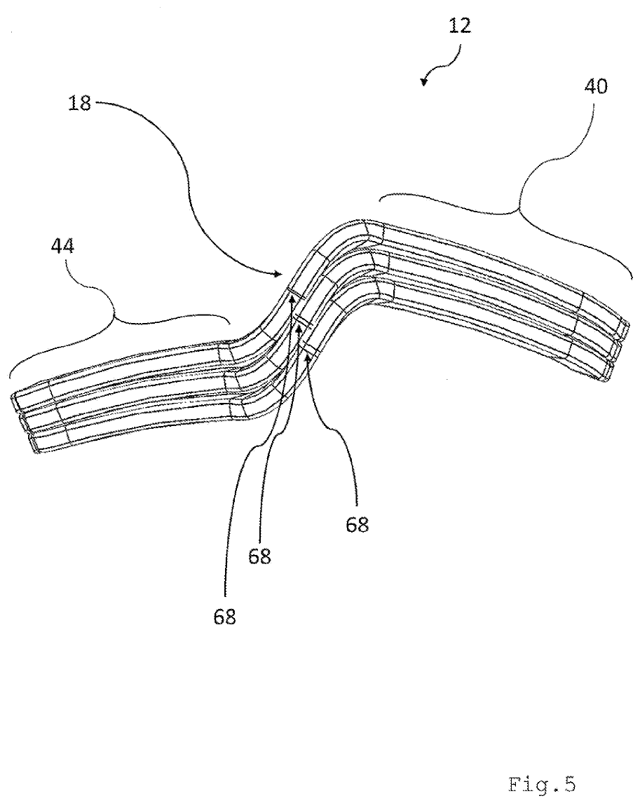

The contour of the first guide surface 38 was impressed on a deformed portion 40 of the first limb 14 and the contour of the second guide surface 42 was impressed on a deformed portion 44 of the second limb 16. For the sake of clarity, the two deformed portions 40, 44 are labeled in FIG. 5.

After the two pivot units 20, 26 have been pivoted, they are locked in their pivoted position since they could otherwise spring back counter to the pivoting direction 56. In the present case, this is implemented by means of stoppers 70 which engage behind the levers 50, 52 and prevent them from swinging back.

After the two pivot units 20, 26 have been pivoted, the shaping element 46 is displaced in the guide direction 39, so that the contact surface 48 is pressed onto the deformed portion 44 of the second limb 16 of the conductor elements 12. In the process, the contour of the working surface 48 is transferred to the deformed portion 44. The deformation of the deformed portion 44 of the second limb 16 thus corresponds to a superimposition of the contours of the working surface 48 and the second guide surface 42.

During the pivoting or bending of the conductor elements 12, the connecting portions 18, which are arranged between the shaping surfaces 35, 37, move downward in the vertical direction, parallel to the pivot axes 24, 30. In FIG. 3, this corresponds to a direction pointing into the plane of the drawing.

This vertical displacement in the vertical direction is performed by all the connecting portions 18 equally. In addition, however, the individual connecting portions 18 of the respective conductor elements 12 are displaced in an orientation direction 58. This is directed perpendicularly to the direction described above which points into the plane of the drawing in FIG. 4.

The displacement of the connecting portions 18 in the orientation direction 58 is different for the individual connecting portions 18. The connecting portions 18 are displaced between the shaping surfaces 35, 37, which represent a guide in the orientation direction 58 for the connecting portions 18.

This displacement results from the fact that a plurality of conductor elements 12 are arranged one next to the other and are bent. The more conductor elements 12 are arranged next to one another and bent, the greater the offset between the displacements of the conductor element 12 shown on the far left in FIG. 4 and the conductor element 12 shown on the far right in FIG. 4.

By pulling apart the first and the second limbs 14, 16 of the conductor elements 12 by pivoting as described above, the connecting portions 18 must be moved in the direction of the limbs 14, 16 and/or the limbs 14, 16 must be moved in the direction of the connecting portions 18 in order to make a length adjustment.

In the present case, this is implemented by means of two movements. On the one hand, the connecting portions 18 move in the direction of the two limbs 14, 16 between the two guide elements 34, 36 by the connecting portions 18 slipping out in the direction of the two limbs 14, 16, in particular guided by the shaping surfaces 35, 37. On the other hand, the first pivot unit 20 is moved in the direction of the connecting portion 18 by means of the ramp 60 described above, and therefore so are the first limbs 14 of the conductor elements 12.

FIG. 5 is a plan view of three conductor elements 12 bent by means of the device 10. The connecting portions 18 and respective deformed portions 40, 44 of the limbs 14, 16 are shown.

Central regions 68 on the connecting portions 18 are indicated by dashes. In the U-shaped initial state of the conductor elements 12 shown in FIG. 1, these correspond to one another and lie on a line. After the conductor elements 12 have been bent, the connecting portions 18 are displaced relative to one another, as can be seen from the displaced central regions 68.

### LIST OF REFERENCE SIGNS

10 device
12 conductor element
14 first limb
16 second limb
18 connecting portion
20 first pivot unit
22 first limb-receiving means
24 first pivot axis
26 second pivot unit
28 second limb-receiving means
30 second pivot axis
32 guide assembly
34 first guide element
35 first shaping surface
36 second guide element
37 second shaping surface
38 first guide surface
39 guide direction
40 deformed portion of the first limb
42 second guide surface
44 deformed portion of the second limb
46 shaping element
48 contact surface
50 first lever
52 second lever
54 roller
56 pivoting direction
58 orientation direction
60 ramp
62 screw thread
64 crank
66 threaded rod
68 central region of the connecting portion
70 stopper

1. Device for bending at least one conductor element which is U-shaped in an initial state and which, in an initial state, consists of a first straight limb, a second straight limb and an arcuate connecting portion which connects the two limbs, wherein the device comprises:
a first pivot unit having a first limb-receiving means which is designed to be pivotable about a first pivot axis on a first circular path and which is designed for clampingly receiving the first limb of the conductor element,
a second pivot unit having a second limb-receiving means which is designed to be pivotable about a second pivot axis, which is arranged at a distance from the first pivot axis, on a second circular path and which is designed for clampingly receiving the second limb of the conductor element,
wherein the first limb-receiving means and the second limb-receiving means can be pivoted away from one another in the same pivoting direction on the respective circular paths,
a guide assembly comprising a first guide element having a first shaping surface and a second guide element having a second shaping surface,
wherein the two guide elements are arranged or can be arranged in such a way that the arcuate connecting portion of a conductor element to be deformed or of a plurality of conductor elements to be deformed and to be arranged one next to the other, in the initial state thereof, can be arranged between the two guide elements in such a way that said conductor elements are guided between the shaping surfaces or can be moved therewith.

2. Device according to claim 1, characterized in that the first guide element and the second guide element can be moved toward and away from one another relative to one another, in particular in a guide direction.

3. Device according to claim 1, characterized in that the device comprises a first guide surface, which is curved and arranged on the first guide element,
the first guide surface being arranged and designed in such a way that when the first pivot unit is pivoted, a deformed portion of the first limb, which extends from the part of the first limb received in the first limb-receiving means in the direction of the connecting portion, is bent against the first guide surface, so that a contour of the first guide surface is at least partially impressed on the deformed portion of the first limb.

4. Device according to claim 1, characterized in that the device (10) comprises a second guide surface, which is curved and is preferably arranged on the second guide element,
the second guide surface being arranged and designed in such a way that when the second pivot unit is pivoted, a deformed portion of the second limb, which extends from the part of the second limb received in the second limb-receiving means in the direction of the connecting portion, is bent against the second guide surface, so that a contour of the second guide surface is at least partially impressed on the deformed portion of the second limb.

5. Device according to claim 1, characterized in that the device comprises at least one shaping element which has a contact surface, the shaping element being arranged and designed in such a way that the contact surface thereof can be pressed against the deformed portion of the first limb or against the deformed portion of the second limb by a movement of the shaping element in the guide direction so that a contour of the contact surface is at least partially impressed on the deformed portion of the first limb or the deformed portion of the second limb.

6. Device according to claim 1, characterized in that the shaping element is arranged and designed in such a way that
the contact surface of the shaping element and the first guide surface or the contact surface of the shaping element and the second guide surface can be moved toward and away from one another relative to one another.

7. Device according to claim 1, characterized in that the first pivot unit is arranged and designed in such a way that the first pivot unit is designed to be movable in a direction parallel to the first pivot axis
and/or
in that the second pivot unit is arranged and designed in such a way that the second pivot unit is designed to be movable in a direction parallel to the second pivot axis.

8. Method for bending at least one conductor element which is U-shaped in an initial state or a conductor element assembly which comprises a plurality of conductor elements arranged one next to the other and which comprises a first straight limb, a second straight limb and an arcuate connecting portion which connects the two limbs, wherein the conductor elements of the conductor element assembly are formed having an identical connecting portion, wherein the method comprises the following steps:
arranging the arcuate connecting portion within a guide assembly,
receiving the first limb in a first limb-receiving means in a clampingly fixed manner,
receiving the second limb in a second limb-receiving means in a clampingly fixed manner,
pivoting the part of the first limb received in the first limb-receiving means on a first circular path about a first pivot axis in a pivoting direction,
pivoting the part of the second limb received in the second limb-receiving means on a second circular path about a second pivot axis in the pivoting direction, wherein the arcuate connecting portion of the conductor element is deformed and displaced parallel to the pivot axes, wherein part of the connecting portion is held in its orientation by the guide assembly.

9. Method according to claim 8, characterized in that when the part of the first limb received in the first limb-receiving means is pivoted, a deformed portion of the first limb, which extends from the part of the first limb that is received in the first limb-receiving means in the direction of the connecting portion, is bent against a first guide surface, so that a contour of the first guide surface is at least partially impressed on the deformed portion of the first limb.

10. Method according to claim 8, characterized in that when the part of the second limb received in the second limb-receiving means is pivoted, a deformed portion of the second limb, which extends from the part of the second limb that is received in the second limb-receiving means in the direction of the connecting portion, is bent against a second guide surface, so that a contour of the second guide surface is at least partially impressed on the deformed portion of the second limb.

11. Method according to claim 8, characterized in that when the part of the first limb received in the first limb-receiving means is pivoted, the first limb-receiving means is moved in a direction parallel to the first pivot axis and/or
in that when the part of the second limb received in the second limb-receiving means is pivoted, the second limb-receiving means is moved in a direction parallel to the second pivot axis.

12. Method according to claim 8, characterized in that the method further comprises the step of:
pressing a contact surface against the deformed portion of the first limb and/or against the deformed portion of the second limb, so that a contour of the contact surface is at least partially impressed on the deformed portion of the first limb and/or the deformed portion of the second limb.

13. Method according to claim 8, characterized in that a device is used when carrying out the method, wherein the device comprises:
a first pivot unit having a first limb-receiving means which is designed to be pivotable about a first pivot axis on a first circular path and which is designed for clampingly receiving the first limb of the conductor element,
a second pivot unit having a second limb-receiving means which is designed to be pivotable about a second pivot axis, which is arranged at a distance from the first pivot axis, on a second circular path and which is designed for clampingly receiving the second limb of the conductor element,
wherein the first limb-receiving means and the second limb-receiving means can be pivoted away from one another in the same pivoting direction on the respective circular paths,
a guide assembly comprising a first guide element having a first shaping surface and a second guide element having a second shaping surface,
wherein the two guide elements are arranged or can be arranged in such a way that the arcuate connecting portion of a conductor element to be deformed or of a plurality of conductor elements to be deformed and to be arranged one next to the other, in the initial state thereof, can be arranged between the two guide elements in such a way that said conductor elements are guided between the shaping surfaces or can be moved therewith.
